(19) United States
(12) Patent Application Publication
(10) Pub. No.: US 2025/0219116 A1
(43) Pub. Date: Jul. 3, 2025

(54) FUEL CELL SYSTEM

(71) Applicants: TOYOTA JIDOSHA KABUSHIKI KAISHA, Toyota-shi (JP); DENSO CORPORATION, Kariya-city (JP)

(72) Inventors: Tsuyoshi MARUO, Okazaki-shi (JP); Seiichi TANAKA, Nagoya-shi (JP); Masashi WADA, Toyota-shi (JP); Hiroyuki SUGANUMA, Aichi-gun (JP); Yusuke KAWASAKI, Kariya-city (JP)

(21) Appl. No.: 18/989,027

(22) Filed: Dec. 20, 2024

(30) Foreign Application Priority Data
Dec. 27, 2023 (JP) 2023-220269

(51) Int. Cl. H01M 8/04746; H01M 8/0432

(52) U.S. Cl. CPC H01M 8/04753; H01M 8/04358

(57) ABSTRACT

To provide a fuel cell system configured to suppress a deterioration of fuel cell catalysts and freezing of fuel cell components. A fuel cell system wherein the fuel cell system comprises a fuel cell, a fuel gas system and a controller; wherein the fuel gas system comprises at least an ejector, a circulation flow path, a first supply line and a second supply line; wherein the circulation flow path is configured to circulate a fuel gas, which is supplied from the ejector to the fuel cell, to the ejector through the fuel cell; wherein the first supply line is configured to supply the fuel gas to the ejector; and wherein the second supply line is configured to supply the fuel gas to the ejector and has a larger circulation gas flow rate than the first supply line.

### TECHNICAL FIELD

The disclosure relates to a fuel cell system.

### BACKGROUND

Various studies have been proposed for fuel cells (FC) as disclosed in Patent Document 1.

Patent Document 1: Japanese Patent Application Laid-Open (JP-A) No. 2022-134844

Patent Document 1 discloses a fuel cell system in which an ejector and a circulation pump are employed for hydrogen supply and the circulation pump is controlled when the temperature of the fuel cell is equal e to or less than a temperature corresponding to activation (start-up) below the freezing point. In the prior art, suppressing a deterioration of a fuel cell catalyst is only considered as a control of the start-up below the freezing point. Accordingly, fuel cell system components (such as an ejector) are likely to freeze.

### SUMMARY

The disclosure was achieved in light of the above circumstances. An object of the disclosure is to provide a fuel cell system configured to suppress a deterioration of fuel cell catalysts and freezing of fuel cell components.

That is, the present disclosure includes the following embodiments.

<1> A fuel cell system,
wherein the fuel cell system comprises a fuel cell, a fuel gas system and a controller;
wherein the fuel gas system comprises at least an ejector, a circulation flow path, a first supply line and a second supply line;
wherein the circulation flow path is configured to circulate a fuel gas, which is supplied from the ejector to the fuel cell, to the ejector through the fuel cell;
wherein the first supply line is configured to supply the fuel gas to the ejector;
wherein the second supply line is configured to supply the fuel gas to the ejector and has a larger circulation gas flow rate than the first supply line;
wherein the controller is configured to supply the fuel gas to the ejector from the first supply line having a relatively small circulation gas flow rate, when a cooling water temperature of the fuel cell is equal to or less than a predetermined temperature at a time of starting the fuel cell system below the freezing point; and
wherein the controller is configured to supply the fuel gas to the ejector from the second supply line having a relatively large circulation gas flow rate, when the cooling water temperature is more than the predetermined temperature at the time of starting the fuel cell system below the freezing point.

<2> The fuel cell system according to <1>,
wherein the first supply line is provided with a first valve;
wherein the second supply line is provided with a second valve;
wherein the controller is configured to open the first valve when the cooling water temperature of the fuel cell is equal to or less than the predetermined temperature at the time of starting the fuel cell system below the freezing point;
wherein the controller is configured to open the second valve when the cooling water temperature is more than the predetermined temperature at the time of starting the fuel cell system below the freezing point; and
wherein an opening degree of the second valve at a time of opening the second valve is smaller than that of the first valve at a time of opening the first valve.

The fuel cell system of the present disclosure can suppress a deterioration of fuel cell catalysts and freezing of fuel cell components.

### BRIEF DESCRIPTION OF THE DRAWINGS

In the accompanying drawings,

FIG. 1 is a system configuration diagram illustrating an example of the fuel cell system of the present disclosure;

FIG. 2 is a timeline chart showing an exemplary control of the fuel cell system of the present disclosure; and

FIG. 3 is a flowchart showing an exemplary control of the fuel cell system of the present disclosure.

### DETAILED DESCRIPTION

Hereinafter, the embodiments of the present disclosure will be described in detail. Matters that are required to implement the present disclosure (such as common structures and production processes of fuel cell systems not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (such as length, width and thickness) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and it may be hydrogen. The oxidant gas is a gas containing oxygen, and it may be oxygen, air or the like.

In the present disclosure, there is provided a fuel cell system,
wherein the fuel cell system comprises a fuel cell, a fuel gas system and a controller;
wherein the fuel gas system comprises at least an ejector, a circulation flow path, a first supply line and a second supply line;
wherein the circulation flow path is configured to circulate a fuel gas, which is supplied from the ejector to the fuel cell, to the ejector through the fuel cell;
wherein the first supply line is configured to supply the fuel gas to the ejector;
wherein the second supply line is configured to supply the fuel gas to the ejector and has a larger circulation gas flow rate than the first supply line;
wherein the controller is configured to supply the fuel gas to the ejector from the first supply line having a relatively small circulation gas flow rate, when the cooling water temperature of the fuel cell is equal to or less than a predetermined temperature at the time of starting the fuel cell system below the freezing point; and
wherein the controller is configured to supply the fuel gas to the ejector from the second supply line having a relatively large circulation gas flow rate, when the cooling water temperature is more than the predetermined temperature at the time of starting the fuel cell system below the freezing point.

In general, there are two types of fuel gas supply to the fuel cell: the supply of the fuel gas from a fuel gas tank and the supply of a fuel off-gas discharged from the fuel cell as a circulation gas.

By the flow rate of the circulation gas, the fuel gas is allowed to be supplied in the amount needed to be delivered to all of the unit cells of the fuel cell, considering a variation in fuel gas distribution.

When the fuel gas amount is controlled so as not to generate the circulation gas, a shortage of the fuel gas occurs in a part of the fuel cell. Power generation in the shortage state causes a deterioration in the fuel cell performance.

On the other hand, when the fuel gas in the fuel gas tank is below the freezing point at the time of starting the fuel cell system below the freezing point and when the fuel gas below the freezing point joins the circulation gas, which contains cold water vapor, inside the ejector, the water vapor of the circulation gas may be frozen to freeze the ejector. When the circulation gas generation is prevented at the time of starting the system below the freezing point, the fuel cell may deteriorate due to the fuel gas shortage.

In the present disclosure, a deterioration of the catalyst of the fuel cell and freezing of the components thereof at the time of starting the system below the freezing point, can be suppressed by switching the fuel gas supply method (the size of the flow rate of the circulation gas) at the time of starting the system below the freezing point, according to the state of the fuel cell.

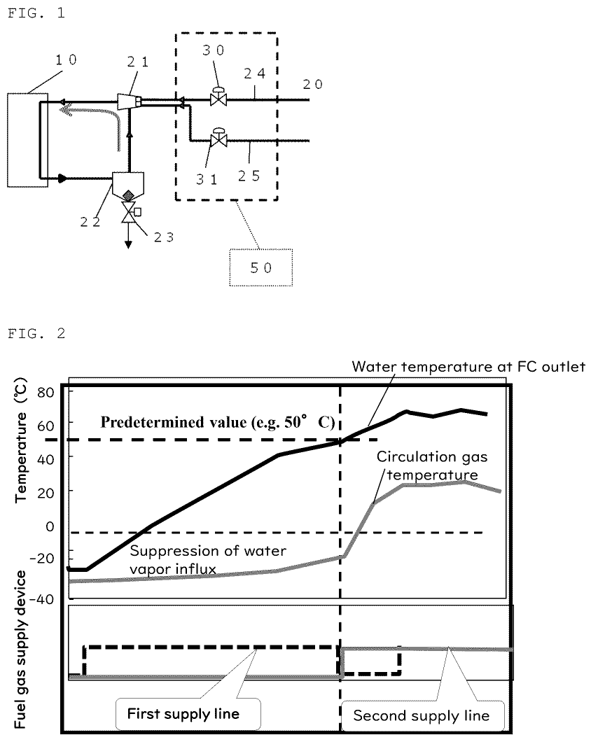

FIG. 1 is a system configuration diagram illustrating an example of a fuel cell system of the present disclosure.

The fuel cell system shown in FIG. 1 includes a fuel cell 10, a fuel gas system 20 and a controller 50. The fuel gas system 20 includes an ejector 21, a gas-liquid separator 22, a gas and water discharge valve 23, a first supply line 24, a second supply line 25 and so on. The first supply line 24 is provided with a linear solenoid valve as a first valve 30 having a relatively small circulation gas flow rate. The second supply line 25 is provided with an injector as a second valve 31 having a relatively large circulation gas flow rate. For simplicity, an oxidant gas system and a cooling system are not illustrated in FIG. 1.

By setting the opening degree of the second valve 31 at the time of opening the second valve smaller than that of the first valve 30 at the time of opening the first valve, in the case of supplying the fuel gas from the second supply line 25 to the ejector 21, the amount of the fuel gas supplied to the ejector 21 becomes smaller than in the case of supplying the fuel gas from the first supply line 24 to the ejector 21. Accordingly, in the second supply line 25, the flow rate of the circulation gas circulating in the fuel cell 10 may be increased higher than the flow rate of the fuel gas supplied to the ejector 21 from the fuel gas tank (not shown).

The fuel cell system of the present disclosure may be mounted and used in a moving body such as a vehicle. Also, the fuel cell system of the present disclosure may be mounted in a stationary power generation system such as a generator that is configured to supply electric power to the outside of the fuel cell system.

The vehicle may be a fuel cell vehicle or the like. As the moving body other than the vehicle, examples include, but are not limited to, a railway, a ship, and an aircraft.

Also, the fuel cell system of the present disclosure may be mounted in a moving body such as a vehicle which is capable of traveling even with the electric power of a secondary battery.

The moving body and the stationary power generation system may include the fuel cell system of the present disclosure. The moving body may include a drive unit such as a motor, an inverter and a hybrid control system.

The hybrid control system may be capable of driving a moving body by using both the output of the fuel cell and the electric power of the secondary battery.

The fuel cell system includes the following: a fuel cell that is configured to generate power by reacting hydrogen and oxygen; a fuel gas system that is configured to supply a fuel gas containing hydrogen, which is necessary for power generation of the fuel cell, to the fuel cell; and the controller.

In general, the fuel cell system further includes an oxidant gas system that is configured to supply an oxidant gas containing oxygen to the fuel cell, and a cooling system that is configured to supply cooling water to the fuel cell for cooling heat generated by power generation.

The fuel cell may have only one unit fuel cell (unit cell), or it may be a fuel cell stack (stack) composed of a stack of unit cells.

In the present disclosure, both the unit cell and the fuel cell stack may be referred to as a fuel cell.

The number of the stacked unit cells of the fuel cell stack is not particularly limited, and it may be two to several hundreds, for example.

The fuel cell stack may include a collector plate, a pressure plate and the like at the end portions in the stacking direction.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. As the solid polymer electrolyte membrane, examples include, but are not limited to, a fluorine-based electrolyte membrane as such a thin film of perfluorosulfonic acid containing moisture, and a hydrocarbon-based electrolyte membrane. The electrolyte membrane may be, for example, a Nafion membrane (manufactured by DuPont).

One of the two electrodes is an anode (a fuel electrode), and the other is a cathode (an oxidant electrode).

The electrode includes a catalyst layer, and it may include a gas diffusion layer, as needed. The power generation unit may be a membrane electrode gas diffusion layer assembly (MEGA).

The catalyst layer contains a catalyst. The catalyst may contain a catalyst metal that promotes an electrochemical reaction, an electrolyte having proton conductivity, a support having electron conductivity, and the like.

As the catalytic metal, for example, platinum (Pt), an alloy composed of Pt and another metal (for example, a Pt alloy obtained by mixing with cobalt, nickel and the like) or the like can be used. The catalyst metal used as a cathode catalyst and the catalyst metal used as an anode catalyst may be the same or different.

The electrolyte may be a fluorine-based resin or the like. As the fluorine-based resin, for example, a Nafion solution or the like may be used.

The catalyst metal is supported on a support. In each of the catalyst layers, the support supporting the catalyst metal (the catalyst-supporting support) may be mixed with the electrolyte.

As the support for supporting the catalyst metal, examples include, but are not limited to, a generally commercially available carbon material such as carbon.

The gas diffusion layer may be a pored electroconductive member or the like.

As the electroconductive member, examples include, but are not limited to, a carbonaceous porous material such as carbon cloth and carbon paper, and a metal porous member such as metal mesh and foam metal.

The unit cell of the fuel cell may include a separator.

The separator collects current generated by power generation and functions as a partition wall. In the unit cell of the fuel cell, a pair of separators are usually disposed on both sides of the power generation unit in the stacking direction so as to sandwich the power generation unit. One of the pair of the separators is an anode separator, and the other is a cathode separator.

The anode separator may have a groove on the power generation unit-side surface thereof, which serves as a fuel gas flow path.

The cathode separator may have a groove on the power generation unit-side surface thereof, which serves as an oxidant gas flow path.

The separators may have holes constituting a manifold such as a supply hole and a discharge hole for allowing a fluid to flow in the stacking direction of the unit cells.

The separators may be, for example, gas-impermeable dense carbon obtained by compressing carbon, or they may be press-formed metal (such as iron, titanium and stainless steel).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and the resin frame forms a seal between the anode separator and the cathode separator in the state that it keeps the membrane electrode assembly in the central region thereof. As the resin frame, for example, a resin such as PE, PP, PET and PEN can be used. The resin frame may be a three-layer sheet composed of an adhesive layer, a substrate layer and an adhesive layer in this order.

The fuel gas system supplies the fuel gas to the fuel cell and regulates the flow rate of the fuel gas.

The fuel gas system includes at least the ejector, the circulation flow path, the first supply line and the second supply line. As needed, the fuel gas system may include a fuel gas tank, a gas-liquid separator, a gas and water discharge valve, a fuel gas pump for fuel gas circulation, and so on.

The ejector may be disposed at the junction of the first and the second supply lines on the circulation flow path. The ejector may have two nozzles and so on, which are nozzles having different circulation gas flow rates due to their different nozzle diameters.

The circulation flow path circulates the fuel gas, which is supplied from the ejector to the fuel cell, to the ejector through the fuel cell. That is, the fuel off-gas discharged from the fuel cell is circulated into the ejector as the circulation gas.

The first supply line supplies the fuel gas to the ejector.

The second supply line supplies the fuel gas to the ejector and has a larger circulation gas flow rate than the first supply line. The fuel gas supply amount in the second supply line may be the same as or smaller than the fuel gas supply amount in the first supply line.

The first supply line may be provided with the first valve.

The second supply line may be provided with the second valve.

The opening degree of the second valve at the time of opening the second valve may be smaller than that of the first valve at the time of opening the first valve.

The first valve may be a fuel gas supply valve for supplying the fuel gas to one of the two nozzles of the ejector, which is a nozzle having a relatively small circulation gas flow rate.

The second valve may be a fuel gas supply valve for supplying the fuel gas to the other one of the two nozzles of the ejector, which is a nozzle having a relatively large circulation gas flow rate.

The first and second valves may be valves that can independently control their opening/closing and their opening degrees, such as an injector and a linear solenoid valve.

The first supply line having a relatively large fuel gas supply amount and the second supply line having a relatively small fuel gas supply amount may be disposed by controlling the opening of the first valve and the second valve, respectively.

The oxidant gas system supplies the oxidant gas to the fuel cell and regulates the flow rate of the oxidant gas. The oxidant gas system may include an oxidant gas supply device, an oxidant gas flow path, an inlet-side sealing valve at the oxidant gas inlet of the fuel cell, an outlet-side sealing valve at the oxidant gas outlet of the fuel cell, and the like.

The oxidant gas supply device may be an air compressor or the like.

The cooling system supplies cooling water to the fuel cell as a cooling medium.

As the cooling water, examples include, but are not limited to, water and ethylene glycol. The cooling water may be a mixture thereof.

The cooling system includes a cooling water pump, a cooling flow path, a radiator, a bypass flow path, a rotary valve, a reserve tank, an ion exchanger, an intercooler, a cooling water temperature sensor and the like.

The cooling water pump circulates the cooling water for cooling the fuel cell and regulates the flow rate of the cooling water supplied to the fuel cell.

The reserve tank is a tank for temporarily storing the cooling water overflowed from the cooling flow path, which due to an increase in the internal pressure of the cooling flow path resulting from an increase in the cooling water temperature.

The cooling flow path is a flow path for circulating the cooling water for cooling the fuel cell inside and outside the fuel cell.

The radiator is disposed on the cooling flow path to cool the cooling water.

The bypass flow path branches from the cooling flow path upstream of the radiator of the cooling flow path, bypasses the radiator, and merges with the cooling flow path downstream of the radiator of the cooling flow path.

The rotary valve is disposed at the branch point between the cooling flow path and the bypass flow path, and it performs flow path switching to switch between the discharge of the cooling water from the fuel cell into the radiator and the discharge of the same into the bypass flow path. The rotary valve may include an electric motor such as an electric actuator to perform the flow path switching.

The cooling water temperature sensor measures the temperature of the cooling water. The cooling water temperature may be the temperature of the cooling water discharged from the cooling water outlet of the fuel cell (cooling water outlet water temperature).

The fuel cell system may include a secondary battery.

The secondary battery may be any chargeable/dischargeable battery, and examples thereof include a nickel-hydrogen secondary battery and a conventionally-known secondary battery such as a lithium-ion secondary battery. The secondary battery may include a power storage element such as an electric double layer capacitor. The secondary battery may have a configuration in which secondary batteries are connected in series. The secondary battery supplies electric power to an air compressor or the like. The secondary battery may be rechargeable from an external power source of the fuel cell system, such as a household power source. The secondary battery may be charged by the output of the fuel cell. The charging and discharging of the secondary battery may be controlled by the controller.

The fuel cell system includes the controller. The controller may control the entire fuel cell system by controlling the fuel gas system, the oxidant gas system, the cooling system and the like.

The controller physically includes, for example, an arithmetic processing unit such as a CPU (central processing unit), a ROM (read-only memory) that stores control programs and control data to be processed by a CPU, a storage device such as a RAM (random access memory) that is mainly used as various working areas for control processing, and an input/output interface. The controller may be an ECU (electronic control unit).

When the cooling water temperature of the fuel cell is equal to or less than the predetermined temperature at the time of starting the fuel cell system below the freezing point, the controller supplies the fuel gas to the ejector from the first supply line having a relatively small circulation gas flow rate.

When the cooling water temperature is more than the predetermined temperature at the time of starting the fuel cell system below the freezing point, the controller supplies the fuel gas to the ejector from the second supply line having a relatively large circulation gas flow rate.

When the cooling water temperature of the fuel cell is equal to or less than the predetermined temperature at the time of starting the fuel cell system below the freezing point, the controller may open the first valve having a relatively small circulation gas flow rate.

When the cooling water temperature of the fuel cell is more than the predetermined temperature at the time of starting the fuel cell system below the freezing point, the controller may open the second valve having a relatively large circulation gas flow rate.

The controller may make the opening degree of the second valve at the time of opening the second valve smaller than that of the first valve at the time of opening the first valve.

The fuel cell system may include an outside temperature sensor.

The outside temperature sensor measures the outside temperature at the time of staring the fuel cell system.

When the outside temperature is below the freezing point, the controller may determine that this is the time to start the fuel cell system below the freezing point.

When the cooling water temperature of the fuel cell is below the freezing point, the controller may determine that this is the time to start the fuel cell system below the freezing point.

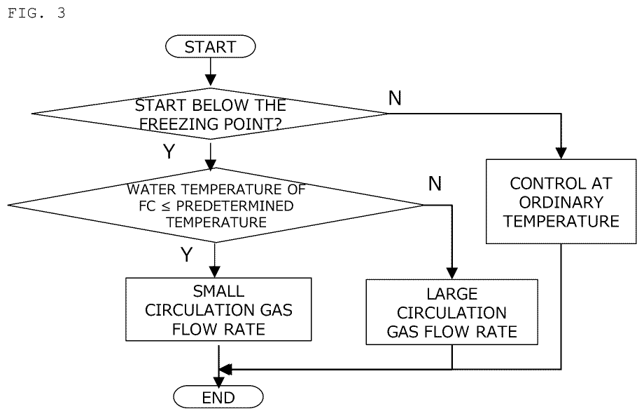

FIG. 2 is a timeline chart showing an exemplary control of the fuel cell system of the present disclosure.

Until the cooling water temperature of the fuel cell reaches a predetermined value (e.g. 50° C.), the fuel gas is supplied by the first valve that is configured to decrease the circulation gas flow rate of the first supply line; moreover, an influx of water vapor is suppressed by lowering the circulation of the circulation gas, thereby suppressing ice formation in the flow path.

After the cooling water temperature of the fuel cell reaches a predetermined value, the fuel gas is supplied by the second valve that is configured to increase the circulation gas flow rate of the second supply line; moreover, freezing the inside of the flow path is avoided by supplying the circulation gas at a sufficient temperature. After the warm-up is completed, the circulation gas supply to the fuel cell is continued to avoid a fuel gas shortage in the fuel cell and avoid a deterioration of the fuel cell.

The time to switch from the first supply line to the second supply line is determined within an existing appropriate range. To suppress the freezing of the ejector and the deterioration of the fuel cell, the switching time is determined within the range that can achieve all of the following three parameters.

### Ice Accretion Amount on the Ejector

At too low temperatures, the circulation gas before the fuel cell is warmed up, the gas containing cold water vapor, flows into the ejector and the inside of the ejector is frozen (ice accretion on the inside of the junction). A large ice accretion amount leads a functional failure (circulation failure) of the ejector. The first and second supply lines are switched at the time when the ice accretion amount becomes equal to or less than the amount that leads to a functional failure.

### Circulation Gas Flow Rate (Circulation Gas Stoichiometric Ratio)

As described above, as the ice accretion amount on the ejector increases, the circulation gas flow rate decreases. Since a deterioration of the fuel cell may be caused by a fuel shortage, the circulation gas flow rate is controlled to be an amount that is equal to or more than the necessary circulation gas flow rate (circulation gas stoichiometric ratio).

### Dry Condition of the Fuel Cell

The fuel gas circulation also has a role in humidifying the inside of the fuel cell. By circulating the water produced in the fuel cell, the water balance in the fuel cell is adjusted. If the fuel cell is operated without the fuel gas circulation, the fuel cell is dried too much and leads to a deterioration of the fuel cell. Since the dry condition (water content) of the fuel cell correlates with impedance, the circulation gas flow rate is controlled so that the impedance of the fuel cell is within a range that does not lead to a deterioration of the fuel cell.

The predetermined temperature is set by the following method. First, a data group is prepared in advance, the group showing the relationship between the cooling water temperature of the fuel cell, which serves as a time cue to switch the supply lines, the ice accretion amount on the ejector, the circulation gas stoichiometric ratio, and the water content of the fuel cell. The cooling water temperature of the fuel cell, which falls within the criterion of all the parameters of the data group, may be set as the predetermined temperature. The predetermined temperature may be in a range of from 40° C. to 60° C.

Besides the cooling water temperature of the fuel cell, the elapsed time since the start of the system below the freezing point, the cumulative heating value of the fuel cell, the temperature increase rate of the fuel cell or the like is applicable as the parameter that can be used to determine the time to switch from the first supply line to the second supply line. When the heating value of the fuel cell is low, the time to switch from the first supply line to the second supply line may be delayed. When the temperature increase rate of the fuel cell is fast, the time to switch the supply lines may be advanced.

FIG. 3 is a flowchart showing an exemplary control of the fuel cell system of the present disclosure.

At the time of starting the operation of the fuel cell system, the controller determines whether or not the temperature measured by the cooling water temperature sensor is below the freezing point. When the temperature measured by the sensor is not below the freezing point, the controller starts the normal operation of the fuel cell. On the other hand, when the temperature measured by the sensor is below the freezing point, the controller determines that this is the time to start the fuel cell system below the freezing point.

At the time of starting the fuel cell system below the freezing point, the controller determines whether or not the cooling water temperature of the fuel cell is equal to or less than the predetermined temperature. When the cooling water temperature of the fuel cell is more than the predetermined temperature, the controller supplies the fuel gas to the ejector from the second supply line having a relatively large circulation gas flow rate, thereby increasing the circulation gas flow rate. Then, the controller completes the control. On the other hand, when the cooling water temperature of the fuel cell is equal to or less than the predetermined temperature, the controller supplies the fuel gas to the ejector from the first supply line having a relatively small circulation gas flow rate, thereby decreasing the circulation gas flow rate. Then, the controller completes the control.

After the elapse of a predetermined time from the decreasing of the circulation gas flow rate and the completion of the control, or following the decreasing of the circulation gas flow rate and the completion of the control, the controller may again determine whether or not the cooling water temperature of the fuel cell is equal to or less than the predetermined temperature.

Instead of determining the cooling water temperature of the fuel cell again, the controller may determine at least one selected from the following: whether or not a predetermined time has passed since the start of the fuel cell system below the freezing point; whether or not the cumulative heating value of the fuel cell is equal to or more than a predetermined cumulative heating value; and whether or not the temperature increase rate of the fuel cell is equal to or more than a predetermined temperature increase rate.

Then, the controller switches the fuel gas supply to the ejector from the first supply line to the second supply line, when at least one of the following conditions is met: the cooling water temperature of the fuel cell is more than the predetermined temperature; a predetermined time has passed since the start of the fuel cell system below the freezing point; the cumulative heating value of the fuel cell is equal to or more than a predetermined cumulative heating value; and the temperature increase rate of the fuel cell is equal to or more than the predetermined temperature increase rate.

### REFERENCE SIGNS LIST

10. Fuel cell
20. Fuel gas system
21. Ejector
22. Gas-liquid separator
23. Gas and water discharge valve
24. First supply line
25. Second supply line
30. First valve
31. Second valve
50. Controller

1. A fuel cell system,
wherein the fuel cell system comprises a fuel cell, a fuel gas system and a controller;
wherein the fuel gas system comprises at least an ejector, a circulation flow path, a first supply line and a second supply line;
wherein the circulation flow path is configured to circulate a fuel gas, which is supplied from the ejector to the fuel cell, to the ejector through the fuel cell;
wherein the first supply line is configured to supply the fuel gas to the ejector;
wherein the second supply line is configured to supply the fuel gas to the ejector and has a larger circulation gas flow rate than the first supply line;
wherein the controller is configured to supply the fuel gas to the ejector from the first supply line having a relatively small circulation gas flow rate, when a cooling water temperature of the fuel cell is equal to or less than a predetermined temperature at a time of starting the fuel cell system below the freezing point; and
wherein, the controller is configured to supply the fuel gas to the ejector from the second supply line having a relatively large circulation gas flow rate, when the cooling water temperature is more than the predetermined temperature at the time of starting the fuel cell system below the freezing point.

2. The fuel cell system according to claim 1,
wherein the first supply line is provided with a first valve;
wherein the second supply line is provided with a second valve;
wherein the controller is configured to open the first valve when the cooling water temperature of the fuel cell is equal to or less than the predetermined temperature at the time of starting the fuel cell system below the freezing point;
wherein the controller is configured to open the second valve when the cooling water temperature is more than the predetermined temperature at the time of starting the fuel cell system below the freezing point; and
wherein an opening degree of the second valve at a time of opening the second valve is smaller than that of the first valve at a time of opening the first valve.
